(19) United States
(12) Patent Application Publication
(10) Pub. No.: US 2005/0099071 A1
(43) Pub. Date: May 12, 2005

(54) Generating device for wheel rim

(76) Inventor: Wen Chang Wang, Tainan Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/705,303

(22) Filed: Nov. 10, 2003

(51) Int. Cl. H02K 7/00

(52) U.S. Cl. 310/67 R

(57) ABSTRACT

A generating device includes a wheel rim, a coil unit mounted on the wheel rim, a rotor mounted in the coil unit, an impeller structure mounted on an end of the rotor to rotate therewith, and a plurality of light emitting members each mounted on the wheel rim and each electrically connected to the coil unit. Thus, the rotor and the impeller structure are co-axial with the wheel rim, so that the rotor and the impeller structure are rotated rigidly and stably without producing an eccentric effect, thereby enhancing the generating effect of the generating device.

### BACKGROUND OF THE INVENTION

1. Field of the Invention

The present invention relates to a generating device, and more particularly to a generating device for a wheel rim.

2. Description of the Related Art

A conventional generating device for a wheel rim 4 in accordance with the prior art shown in FIGS. 5-8 comprises a coil unit 3 mounted on the wheel rim 4, a rotor 2 mounted in the coil unit 3, an eccentric block 1 mounted on the rotor 2 by a bearing 10, and a plurality of light emitting members 40 each mounted on the wheel rim 4 and each electrically connected to the coil unit 3.

In operation, when the wheeled vehicle (not shown) is moved, the wheel rim 4 is rotated by rotation of the tire (not shown), so that the coil unit 3 is rotated with the wheel rim 4 synchronously, while the rotor 2 and the eccentric block 1 are driven to rotate in an eccentric manner. At this time, the rotor 2 and the eccentric block 1 are not synchronously rotated with the wheel rim 4 due to the eccentric effect, thereby producing a velocity differential between the coil unit 3 and the rotor 2. Thus, the coil unit 3 and the rotor 2 are rotated at different velocities, so that the coil unit 3 produces a magnetic variation by the magnetic shearing effect between the coil unit 3 and the rotor 2 to provide a generating effect so as to provide the electric power to the light emitting members 40, thereby achieving the light emitting effect.

However, the rotor 2 and the eccentric block 1 are rotated in an eccentric manner, so that the generating effect is not produced stably, thereby decreasing the generating efficiency of the conventional generating device. In addition, the weight of the wheel rim 4 is not balanced due to provision of the eccentric block 1, so that rotation of the wheel rim 4 is disposed at an unstable state, thereby affecting movement of the wheeled vehicle.

### SUMMARY OF THE INVENTION

The primary objective of the present invention is to provide a generating device for a wheel rim.

Another objective of the present invention is to provide a generating device, wherein the rotor and the impeller structure are co-axial with the wheel rim, so that the rotor and the impeller structure are rotated rigidly and stably.

A further objective of the present invention is to provide a generating device, wherein the rotor and the impeller structure are rotated rigidly and stably without producing an eccentric effect, thereby enhancing the generating effect of the generating device.

In accordance with the present invention, there is provided a generating device, comprising:
a wheel rim;
a coil unit mounted on the wheel rim;
a rotor mounted in the coil unit; and
an impeller structure mounted on an end of the rotor to rotate therewith.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a generating device in accordance with the preferred embodiment of the present invention;

FIG. 2 is a plan assembly view of the generating device as shown in FIG. 1;

FIG. 3 is a partially side plan cross-sectional view of the generating device as shown in FIG. 1;

FIG. 4 is a side plan cross-sectional assembly view of the generating device as shown in FIG. 1;

FIG. 5 is an exploded perspective view of a conventional generating device in accordance with the prior art;

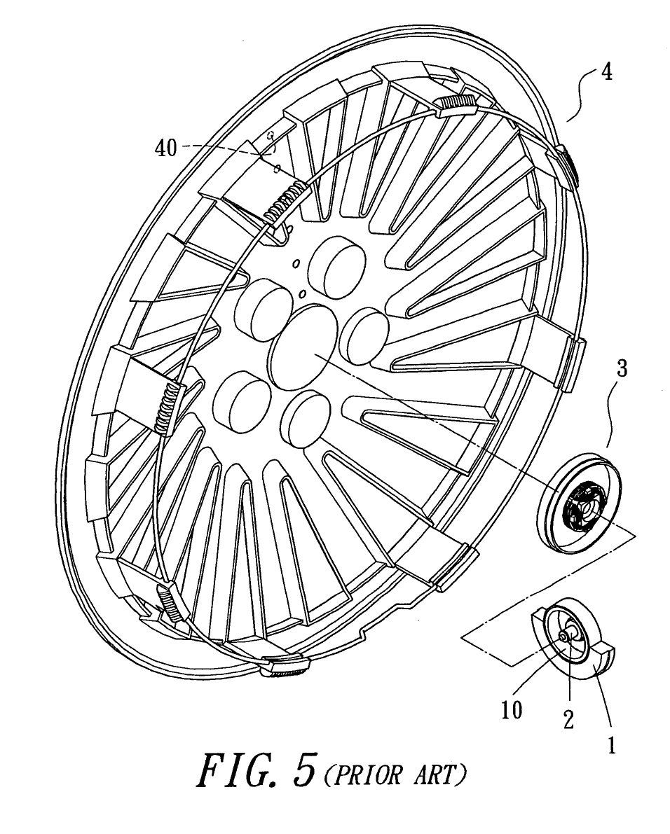

FIG. 6 is a plan assembly view of the conventional generating device as shown in FIG. 5;

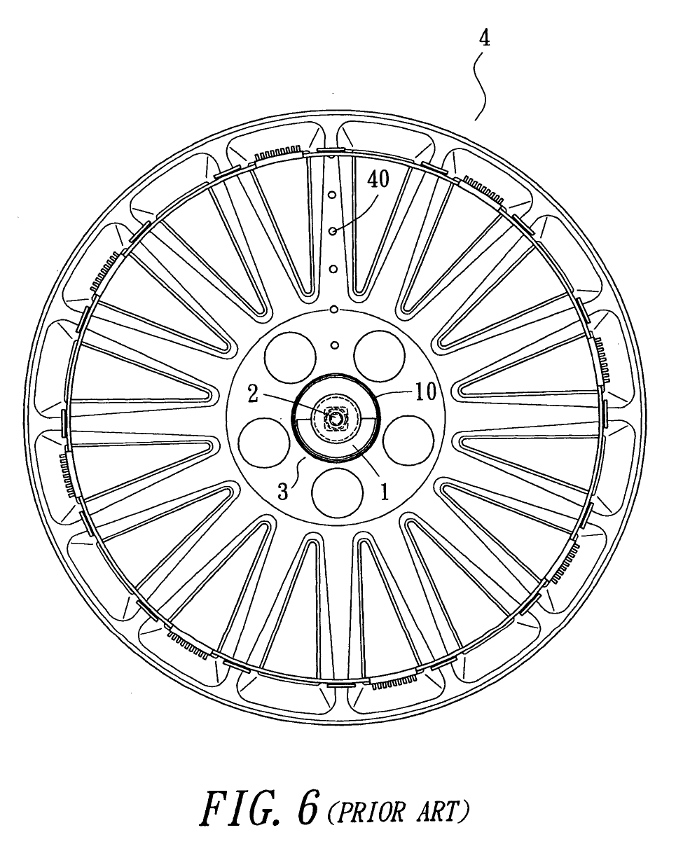

FIG. 7 is a partially side plan cross-sectional view of the conventional generating device as shown in FIG. 5; and

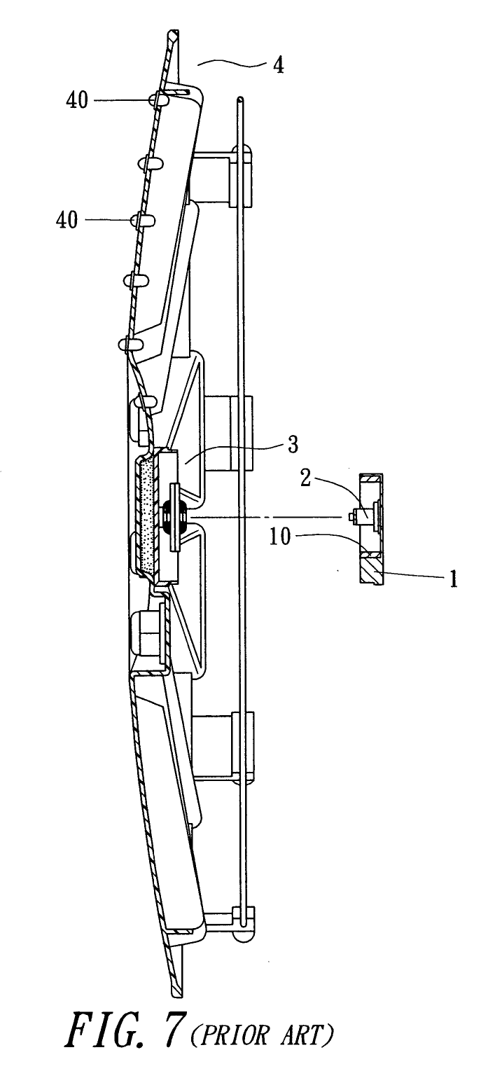

FIG. 8 is a side plan cross-sectional assembly view of the conventional generating device as shown in FIG. 5.

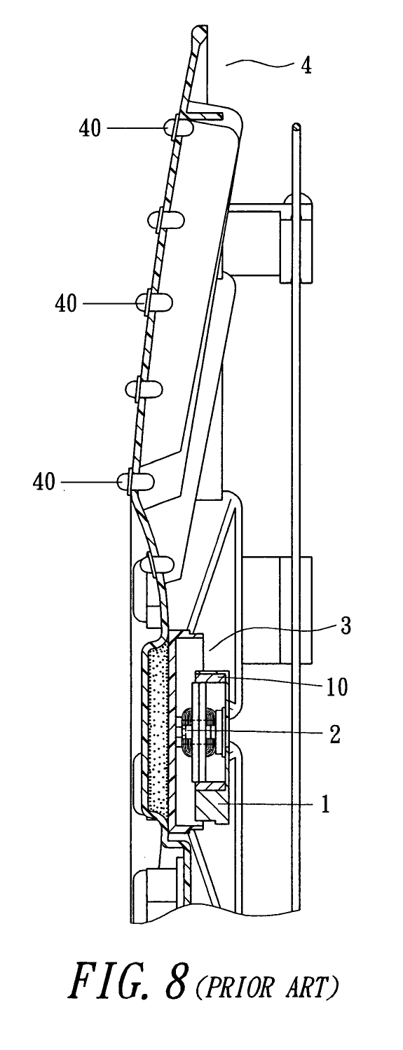

### DETAILED DESCRIPTION OF THE INVENTION

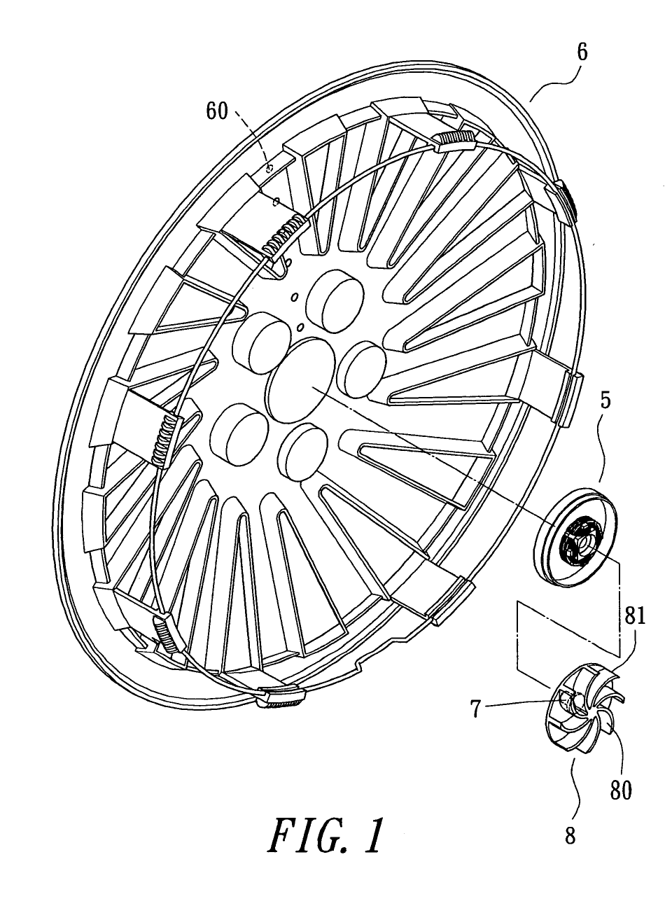

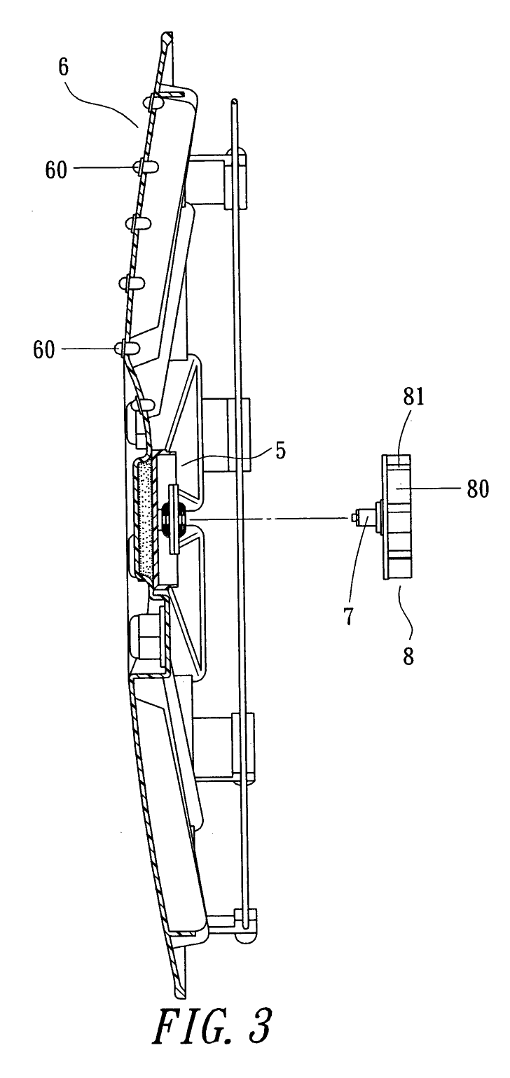

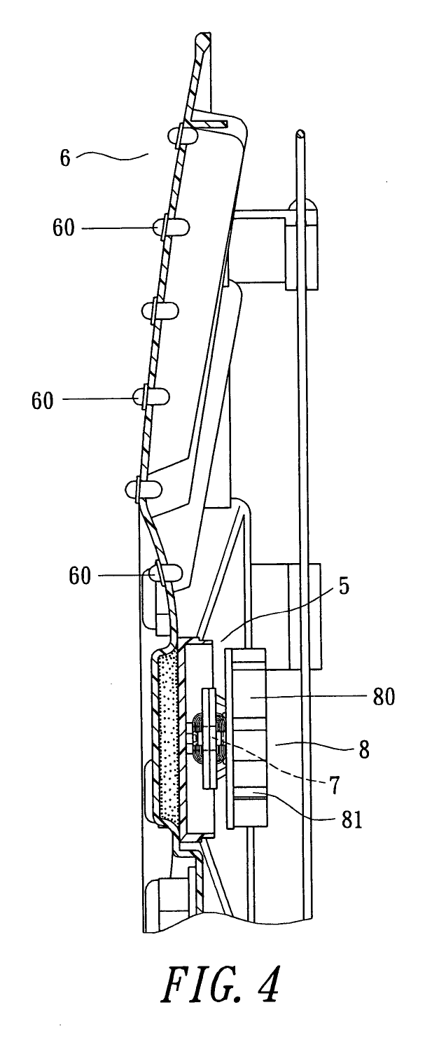

Referring to FIGS. 1-4, a generating device for a wheel rim 6 in accordance with the preferred embodiment of the present invention comprises a coil unit 5 mounted on the wheel rim 6, a rotor 7 mounted in the coil unit 5, and an impeller structure 8 mounted on an end of the rotor 7 to rotate therewith and provided with a plurality of blades 80.

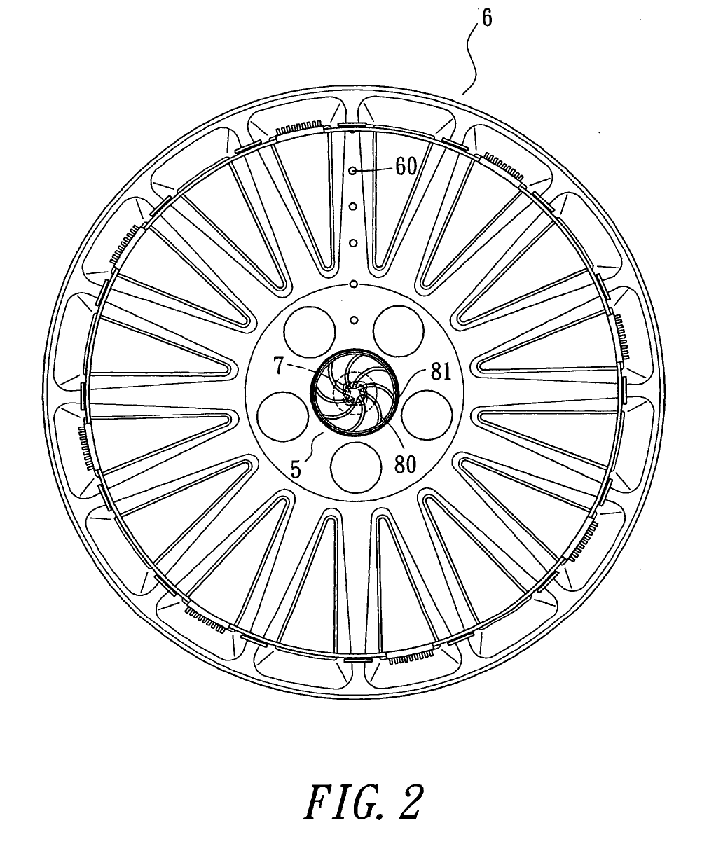

The coil unit 5 is fixedly mounted on a central portion of the wheel rim 6 as shown in FIG. 2. The blades 80 of the impeller structure 8 are arranged in a radiating manner. Each of the blades 80 of the impeller structure 8 is substantially arc-shaped, and has a distal end formed with a wind shear edge 81. In addition, the rotor 7 and the impeller structure 8 are co-axial with the wheel rim 6.

The generating device further comprises a plurality of light emitting members 60 each mounted on the wheel rim 6 and each electrically connected to the coil unit 5.

In operation, when the wheeled vehicle (not shown) is moved, the wheel rim 6 is rotated by rotation of the tire (not shown), so that the coil unit 5 is rotated with the wheel rim 6 synchronously, while the rotor 7 and the impeller structure 8 are driven to rotate by the coil unit 5. At this time, the rotor 7 and the impeller structure 8 are not rotated with the wheel rim 6 synchronously due to an eddy resistance effect of a wind power, thereby producing a velocity differential between the coil unit 5 and the rotor 7.

Thus, the coil unit 5 and the rotor 7 are rotated at different velocities, so that the coil unit 5 produces a magnetic variation by the magnetic shearing effect between the coil unit 5 and the rotor 7 to provide a smooth and stable generating effect so as to provide the electric power to the light emitting members 60, thereby achieving the light emitting effect.

In addition, the wheel rim 6 is available for a wheeled vehicle, such as the car, motorcycle, bicycle or the like.

Accordingly, the rotor 7 and the impeller structure 8 are co-axial with the wheel rim 6, so that the rotor 7 and the impeller structure 8 are rotated rigidly and stably. In addition, the rotor 7 and the impeller structure 8 are rotated rigidly and stably without producing an eccentric effect, thereby enhancing the generating effect of the generating device.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A generating device, comprising:
a wheel rim;
a coil unit mounted on the wheel rim;
a rotor mounted in the coil unit; and
an impeller structure mounted on an end of the rotor to rotate therewith.

2. The generating device in accordance with claim 1, wherein the impeller structure is provided with a plurality of blades.

3. The generating device in accordance with claim 2, wherein the blades of the impeller structure are arranged in a radiating manner.

4. The generating device in accordance with claim 2, wherein each of the blades of the impeller structure is substantially arc-shaped.

5. The generating device in accordance with claim 2, wherein each of the blades of the impeller structure has a distal end formed with a wind shear edge.

6. The generating device in accordance with claim 1, wherein the rotor and the impeller structure are co-axial with the wheel rim.

7. The generating device in accordance with claim 1, wherein the coil unit is fixedly mounted on a central portion of the wheel rim.

8. The generating device in accordance with claim 1, further comprising a plurality of light emitting members each mounted on the wheel rim and each electrically connected to the coil unit.

9. The generating device in accordance with claim 1, wherein when the wheel rim is rotated, the coil unit is rotated with the wheel rim synchronously, while the rotor and the impeller structure are driven to rotate by the coil unit and are not rotated with the wheel rim synchronously due to an eddy resistance effect of a wind power, thereby producing a velocity differential between the coil unit and the rotor.

10. The generating device in accordance with claim 9, wherein the coil unit and the rotor are rotated at different velocities, so that the coil unit produces a magnetic variation between the coil unit and the rotor to provide a generating effect.
